(19) United States
(12) Patent Application Publication
(10) Pub. No.: US 2026/0036415 A1
(43) Pub. Date: Feb. 5, 2026

(54) SYSTEM AND METHOD TO MONITOR AND MEASURE CONDUCTOR IN-CIRCUIT

(71) Applicant: DELL PRODUCTS L.P., Round Rock, TX (US)

(72) Inventors: Sandor Farkas, Round Rock, TX (US); Bhyrav Mutnury, Round Rock, TX (US)

(21) Appl. No.: 18/788,351

(22) Filed: Jul. 30, 2024

(51) Int. Cl. G01B 7/02; G01M 3/00

(52) U.S. Cl. CPC G01B 7/02; G01M 3/007

(57) ABSTRACT

An apparatus includes a monitor and measurement circuit (MMC), a processor, and a memory. The MMC includes a voltage divider circuit and a voltage source. The voltage divider is connected to a conductor which is placed on a path through circuit elements. The voltage source is applied to voltage divider circuit to drive the voltage divider circuit at N frequencies. The memory contains instructions that, when executed by the processor, cause the processor to perform operations including calculating N values of a transfer function of the MMC at the N frequencies, obtaining a sinusoidal function that fits the N values, and calculating length of the conductor based on an argument of the sinusoidal function.

### FIELD OF THE DISCLOSURE

This disclosure generally relates to monitoring and measurement, and more particularly relates to monitoring and measurement of conductors in-circuit.

### BACKGROUND

As the value and use of information continues to increase, individuals and businesses seek additional ways to process, store, and display information. One option is an information handling system. An information handling system generally processes, compiles, stores, communicates and/or display information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, display, and communicate information and may include one or more computer systems, data storage systems, and networking systems.

As technology becomes advanced, information handling systems become increasingly complex. To meet demands for high performance, information handling systems are packed with a large amount of semiconductor chips, computing circuits, and many peripheral and interfacing elements. Such systems typically consume a lot of power and generate excessive heat that may cause educed quality and even damage to the systems. To reduce heat, cooling techniques have been developed. These techniques, however, may create problems such as leaks. Leak detection, therefore, is useful to monitor the integrity of the cooling system.

### SUMMARY

An apparatus includes a monitor and measurement circuit (MMC), a processor, and a memory. The MMC includes a voltage divider circuit and a voltage source. The voltage divider is connected to a conductor which is placed on a path through circuit elements. The voltage source is applied to voltage divider circuit to drive the voltage divider circuit at N frequencies. The memory contains instructions that, when executed by the processor, cause the processor to perform operations including calculating N values of a transfer function of the MMC at the N frequencies, obtaining a sinusoidal function that fits the N values, and calculating length of the conductor based on an argument of the sinusoidal function.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating a system according to an embodiment of the present disclosure;

FIG. 2 is a diagram illustrating the segmentation of the conductor into regions of various criticality levels according to another embodiment of the present disclosure;

FIG. 3 is a diagram illustrating a measurement and monitor circuit according to an embodiment of the present disclosure;

FIG. 4 is a diagram illustrating curve fitting of data to a sinusoidal curve according to an embodiment of the present disclosure;

FIG. 5 is a flowchart illustrating a process to monitor failure and/or measure length of a conductor according to an embodiment of the present disclosure;

FIG. 6 is a flowchart illustrating a process to determine if there is a failure according to an embodiment of the present disclosure;

FIG. 7 is a flowchart illustrating a process to calculate values of the transfer function H(f) according to an embodiment of the present disclosure;

FIG. 8 is a flowchart illustrating a process to monitor a failure condition of a conductor according to an embodiment of the present disclosure;

FIG. 9 is a block diagram illustrating a control circuit according to an embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

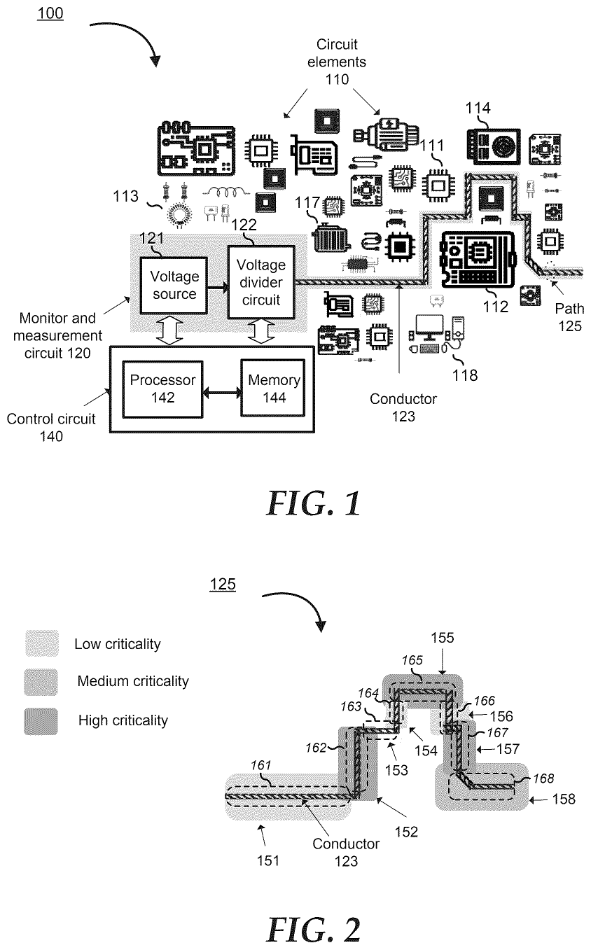

FIG. 1 is a block diagram illustrating a system 100 according to an embodiment of the present disclosure. The system 100 includes circuit elements 110, a measurement and monitor circuit (MMC) 120, and a control circuit 140. The system 100 may include more or less than the above elements.

Circuit elements 110 include elements, components, parts, devices, assemblies, or subsystems used in a typical electronic, electrical, mechanical, or optical application or any combination of these applications. These applications may include computing, networking, server, multimedia, etc. Circuit elements 110 may be assembled in printed circuit boards, packaged in various configurations, and placed in rooms, shelves, racks, or any environment. In applications where heat dissipation is high due to high power consumption, circuit elements 110 may include cooling equipment or devices such as cold plates, fluidic pipes, coolant distribution units (CDUs), heat exchangers, chillers, and cooling towers. As shown in FIG. 1, circuit elements 110 may include integrated circuits or semiconductor devices 111, circuit boards 112, discrete components (e.g., capacitors, resistors, inductors) 113, power supplies 114, cooling unit 117, and input and output devices (e.g., display monitor, keyboard, mouse, printer) 118.

The monitor and measurement circuit (MMC) 120 is configured to monitor the failure condition of a conductor 123 and to measure length of the conductor 123 at runtime or in-circuit while the system is running. The conductor 123 may be any element that is used to transmit information. It may be part of a leak detector rope that is used to detect leaks in a cooling environment. It may also be a transmission line designed to conduct electromagnetic waves. It may include a voltage source 121 and a voltage divider circuit 122. The voltage source 121 is configured to be applied to the voltage divider circuit 122 to drive the voltage divider circuit 122 at N frequencies. In other words, the voltage source provides an alternative current (AC) voltage source at frequencies that can be changed, controlled, or programmed. The number N is an integer greater than zero. N may be selected to be sufficient for a curve fitting procedure. In one embodiment, N may be selected from 4 to 20. The voltage source 121 may be controlled by the control unit 140 to generate an input voltage to the voltage divider 122 at a specified frequency. The voltage divider 122 is configured to be connected to the conductor 123 which is placed on a path 125 through circuit elements 110. The path 125 may be selected or designed to go through relevant areas or regions in the system 100. These areas or regions may be relevant to the application of the system 100 such as heat, noise, or power consumption. The path 125 may have segments that are straight, slanted, curved, or have sharp turns through the circuit elements 110. In a typical scenario, the conductor 123 functioning as a leak detect rope is fragile, especially when bent around sharp corners on the path 125. In addition, the environment where the conductor 123 runs through the path 125 may add further stress to the conductor 123. Under severe conditions, the conductor 123 may encounter failures such as short circuit or open circuit and it may not be functional as intended. Accordingly, it is particularly useful to detect these conditions during runtime and to identify the location of the discontinuity so that proper correction and fault containment policies can be developed. The MMC 120 is a simple circuit and can be implemented as part of the system to provide such an efficient tool for monitoring and measurement in runtime. It may be used for tasks other than measuring the length L of the conductor 123 in cases of failures. For example, it may be used for maintaining a log of normal values of the transfer function H(f) or the output voltage Vₒᵤₜ for a given input voltage Vᵢₙ. This log of normal values may be used to determine if there is a failure in the conductor 123 as will be discussed later.

The control unit 140 is configured to control the MMC 120. It may read status words, issue control words, write commands, or activate input/output functions through interface devices such as input/output (I/O ports or channels, switching circuits, relays, or operational amplifiers. It may activate switching functions to change voltage amplitude and/or the frequency of the voltage source 121. It may read the voltage level at the output of the voltage divider circuit 122. The control unit 140 may include a processor 142 and a memory 144. It will be further described in FIG. 9. The processor 142 may be a programmable device that can execute instructions or programs. The memory 144 may contain instructions that, when executed by the processor 142, cause the processor 142 to perform operations described in this disclosure. In one embodiment, the operations may include measuring N input and output voltages of the voltage divider circuit 122 at the N frequencies, calculating N values of a transfer function of the measurement circuit 120 based on the N input and output voltages, obtaining a sinusoidal function that fits the N values, and calculating length of the conductor 123 based on the argument of the obtained sinusoidal function. In another embodiment, the operations may include obtaining characterized regions of criticality and calculated lengths, inferring failure type based on failure criteria (e.g., goodness of fit, characterized regions of criticality, calculated lengths, and known normal length), and generating alarm or sending failure report if there is a failure.

FIG. 2 is a diagram illustrating the path 125 that shows segmentation of the conductor 123 into regions of various criticality levels according to another embodiment of the present disclosure. In this example, the path 125 is shown to go through eight regions of different levels of criticality: regions 151, 152, 153, 154, 155, 156, 157, and 158. The meaning of criticality depends on the objectives of monitoring the system 100. These objectives may include considerations of parameters such as power consumption, heat generation, noise susceptibility, mechanical stability, or electromagnetic interferences. Circuit elements 110 may exhibit characteristics that are known in advance to consume high power, generate heat, be sensitive to noise, etc. For example, high computing semiconductor integrated circuits are often power hungry and generate a large amount of heat in running mode. When they are clustered in a confined area, they may form a region of high criticality in terms of power consumption. By designating regions in the environment where the path 125 goes through, it is possible to use this information to infer certain conditions on the conductor 123.

Suppose there are three levels of criticality: high, medium, and low, indicated by the shading of the region. Regions 151, 153, 154, and 156 have light shades. They are considered having low criticality (e.g., low power consumption). Region 158 has medium shade. It is considered having medium criticality. Regions 152, 155, and 157 have dark shades. They are considered having high criticality. The corresponding segments on the conductor 123 will be marked to have these criticality levels. These segments are 161, 162, 163, 164, 165, 166, 167, and 168 corresponding to regions 151, 152, 153, 154, 155, 156, 157, and 158, respectively. Characterizing the criticality of these segments helps in inferring certain conditions of the segment. It may be used to estimate the probability of occurrence of a certain event as part of an inference procedure regarding the monitoring of failure mode. Additional heuristic rules may be developed to aid in the inference procedure.

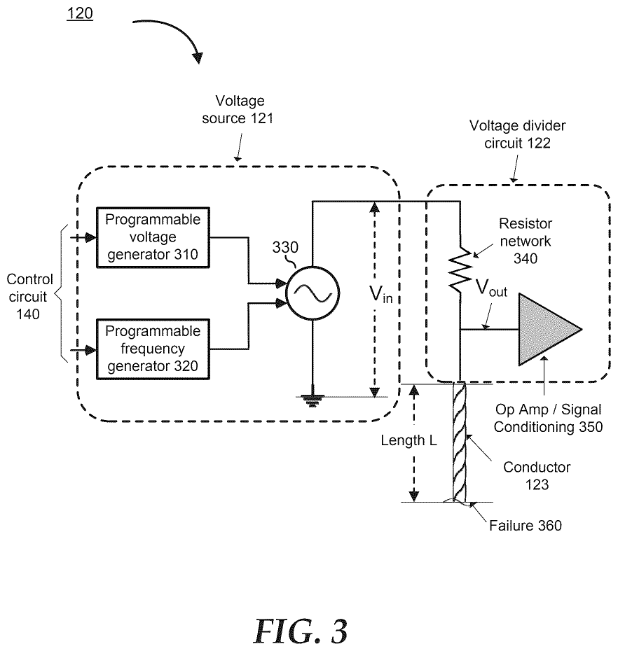

FIG. 3 is a diagram illustrating the MMC 120 according to an embodiment of the present disclosure. The MMC 120 includes the voltage source 121 and the voltage divider circuit 122 as shown in FIG. 1. The MMC 120 is configured to perform two basic functions: monitoring a failure condition of the conductor 123 and measuring a length of the conductor 123 in a failure condition. The MMC 120 performs these functions by generating a series of test data including input voltages, making a series of measurements including output voltages, and estimating the length using a curve fitting procedure based on a sinusoidal function based on a transfer function obtained by the input and output voltages. The derivation of the sinusoidal function as a result of a failure of open or short circuit will be shown later.

The voltage source 121 provides a programmable voltage source to the voltage divider circuit 122. This programmable voltage source may be programmed or set by the control circuit 140 to specified voltage amplitudes and frequencies. In one embodiment, the voltage source 121 may include a programmable voltage generator 310, a programmable frequency generator 320, and a voltage integrator 330. The programmable voltage generator 310, the programmable frequency generator 320, and the voltage integrator 330 may be combined into one or more separate components. The programmable voltage generator 310 generates a voltage signal at a predetermined amplitude level specified by a control word issued from the control circuit 140. The programmable voltage generator 310 may be implemented by a number of methods as is known by one skilled in the art such as precision reference voltage regulators with direct current (DC)-DC converters, programmable gain amplifiers, programmable digital-to-analog converters, etc. The programmable frequency generator 320 generates an alternating current (AC) signal at a frequency specified by a control word issued from the control circuit 140. The programmable frequency generator 320 may be implemented by a number of methods as is known by one skilled in the art such as DC-to-AC converters, voltage-controlled oscillators (VCOs), or frequency synthesizers, etc. The voltage integrator 330 combines the signals from the programmable voltage generator 310 and the programmable frequency generator 320 to produce an AC signal having a predetermined amplitude and a predetermined frequency. The voltage integrator 330 may be implemented as a modulator that modulates the signal from the programmable voltage generator 310 with the signal from programmable frequency generator 320. As mentioned earlier, these devices may be integrated into a single device to produce the same results. The objective of the voltage source is to generate a set of voltage sources having predetermined amplitude and frequency to drive the voltage divider circuit 122 and the conductor 123.

The voltage divider circuit 122 may include a resistor network 340 and a signal conditioning circuit 350. The voltage divider circuit 122 is connected to the conductor 123 to allow driving the conductor 123 at a known voltage levels to determine a length L corresponding to the length of the conductor 123 from the start or origin to the location of a failure 360. The failure 360 may be an open circuit or a short circuit. The resistor network 340 represents a resistance in a typical voltage divider network. It acts as a characteristic impedance Z₀ in a matched series resistance. Its value may be relevant to the calculations of the length L and therefore may be programmable or adjusted by the control circuit 140. The objective of the resistor network 340 is to provide a load, or the characteristic impedance Z₀, for the output circuit to provide the output voltage Vₒᵤₜ. The signal conditioning circuit 320 may provide signal conditioning for the output voltage Vₒᵤₜ such as acting as some sort of terminating or reflecting impedance. It may be placed before the Vₒᵤₜ to provide any necessary filtering or conditioning process.

The conductor 123 is connected to one end of the resistor network 310 and acts as a transmission line. When there is no failure, the conductor 123 exhibits no abnormal behavior. Any attempt to measure the length L in the assumption that there is a failure, when there is in fact no failure, will result in an invalid result. Accordingly, an invalid result is an indicative of a no failure condition. Examples of an invalid result for the calculated length L include: (1) L is too small (e.g., negative) or too large (e.g., much larger than the known normal length), (2) the curve fitting results in an abnormally poor result, such as very poor goodness of fit, and (3) inconsistent results obtained by additional testing circuits. In the following, we will derive expressions for the length L of the conductor 123 in the condition of failure of open circuit or short circuit.

The input impedance Zᵢₙ is a function of length and frequency and may be expressed in terms of the characteristic impedance Z₀ and length L depending on whether the transmission line is normal or has a failure. Two common failures are open circuit and short circuit. A transmission line that is terminated un an open or short circuit is referred to as a stub. These expressions are as follows:

For normal conditions:

$${Z}_{in} ( F , L ) = {Z}_{0} \{ ( {Z}_{L} + j {Z}_{0} tan β L ) / ( {Z}_{0} + j {Z}_{L} tan β L ) \} \qquad ( 1 )$$

For open circuit:

$${Z}_{in} ( F , L ) = - j cot β L \qquad ( 2 )$$

For short circuit:

$${Z}_{in} ( F , L ) = + j {Z}_{0} cot β L \qquad ( 3 )$$

where j=\sqrt{−1} and is associated with the imaginary part of a complex number representation, cot( ) is the cotangent function, and β is the phase propagation constant, β=2π/λ, and λ is the wavelength, λ=c/f, where c is the speed of light and f is the frequency. We can express BL as:

$$β L = 2 π Lf / c = Kf \qquad ( 4 )$$

$$where K = 2 π L / c \qquad ( 5 )$$

When the MMC 120 drives the conductor 123 with the voltage source 121 and a matched series resistance in the voltage divider circuit 122, the circuit has a transfer function H(f) as a ratio of the output voltage Vₒᵤₜ(f) and input voltage Vᵢₙ(f). The input voltage Vᵢₙ(f) may be generated by the voltage source 121 and the output voltage Vₒᵤₜ(f) may be measured at the voltage divider circuit 122. For each Vᵢₙ(f) and Vₒᵤₜ(f) pair, a transfer function H(f) may be computed. If H(f) is shown to be related to the factor K above, the length L may be determined. In the following, it is shown that indeed H(f) is related to Kf by a sinusoidal function.

$$H ( f ) = \frac{{v}_{out} ( f )}{{v}_{in} ( f )} \qquad ( 4 a )$$

$$H ( f ) = \frac{{z}_{in} ( f )}{{z}_{in} ( f ) + {z}_{0}} \qquad ( 4 b )$$

Let's consider the case of open-circuit failure where Zᵢₙ (F, L)=−j Z₀ cot βL as shown in equation (2). The case of short-circuit failure may be similarly derived.

$$H ( f ) = \frac{- j {z}_{0} cot ( Kf )}{- j {z}_{0} cot ( Kf ) + {z}_{0}} \qquad ( 4 c )$$

$$H ( f ) = \frac{cot ( Kf )}{cot ( Kf ) + j} \qquad ( 4 d )$$

$$H ( f ) = \frac{cot ( Kf ) ( cot ( Kf ) - j )}{{cot}^{2} ( Kf ) + 1} \qquad ( 4 e )$$

$$\vert H ( f ) \vert = sqrt \{ \frac{{cot}^{4} ( Kf )}{{( {cot}^{2} ( Kf ) + 1 )}^{2}} + \frac{{cot}^{2} ( Kf )}{{( {cot}^{2} ( Kf ) + 1 )}^{2}} \} \qquad ( 4 f )$$

$$\vert H ( f ) \vert = sqrt \{ \frac{{cot}^{2} ( Kf )}{{cot}^{2} ( Kf ) + 1} \} \qquad ( 4 g )$$

Replacing cot( ) with cos( )/sin( ):

$$\vert H ( f ) \vert = sqrt \{ \frac{{cos}^{2} ( Kf ) / {sin}^{2} ( Kf )}{{cos}^{2} ( Kf ) / {sin}^{2} ( Kf ) + 1} \} \qquad ( 4 h )$$

Simplifying:

$$\vert H ( f ) \vert = sqrt \{ {cos}^{2} ( Kf ) \} \qquad ( 4 i )$$

$$\vert H ( f ) \vert = cos ( Kf ) \qquad ( 4 j )$$

For short circuit, a similar derivation provides:

$$\vert H ( f ) \vert = sin ( Kf ) \qquad ( 4 j )$$

Since cos(θ)=sin(π/2−θ) and sin(θ)=cos(π/2−θ), the two functions are related. They are called sinusoidal functions. One set of data points that are curve fitted to a cosine function may also be curve fitted to a sine function. The difference between the two is the phase shift π/2. This phase shift will cause the calculation of the length L to be offset by a large value. Knowing the range of the length L in a typical conductor will therefore help to identify whether a failure is a open circuit or a short circuit. In addition, other circuit characteristics may be employed to determine whether a failure is an open circuit or a short circuit. For example, a short circuit increases the current significantly and an open circuit leads to zero voltage potential. The regions of criticality in FIG. 2 may help providing criteria for inference.

Once K is determined, length L can be calculated as:

$$L = Kc / 2 π \qquad ( 5 )$$

K may be determined from the argument θ=Kf of the cosine function in equation (4j). The argument θ may be obtained by obtaining the cosine function that best fits a set of data |Hᵢ(f)| where i=1, . . . N. The best-fit cosine function may be obtained by a least-squares curve fitting procedure on a set of N values of |Hᵢ(f)|.

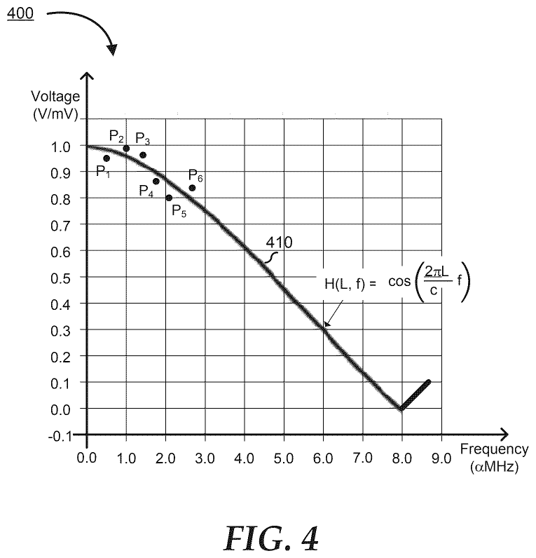

FIG. 4 is a diagram illustrating curve fitting 400 of data to a sinusoidal curve according to an embodiment of the present disclosure. The curve fitting 400 includes fitting a set of data to a curve represented by a mathematical function that minimizes some predefined error. The example shown in FIG. 4 includes 6 data points P₁, P₂, P₃, P₄, P₅, and P₆ and a curve 410. These 6 data points and the curve 410 are defined in a coordinate system for a voltage signal. The abscissa (horizontal axis) represents frequency having a unit of MHz. Other frequency values may be used. The values on the abscissa are not exact and are scaled by the scale factor α (e.g., αMHz). The ordinate (vertical axis) represents the amplitude of a voltage signal with a proper voltage unit such as Volt (V) or millivolt (mV). The data points P₁, P₂, P₃, P₄, P₅, and P₆ and the curve 410 represent the transfer function |H(f)|=cos (Kf) in equation (4j). The data points P₁, P₂, P₃, P₄, P₅, and P₆ are the measurements of |H(f)| at the corresponding frequency values. The curve 410 is the cosine function in closed form. Since |H(f)| is supposed to be cos(Kf) and the data points P₁, P₂, P₃, P₄, P₅, and P₆ are the discrete values of |H(f)|, the problem is stated as: Determine the value of K such that the data points P₁, P₂, P₃, P₄, P₅, and P₆ best fits the function cos(Kf) or fits the function cos(Kf) while minimizing some predefined error. There are many algorithms for curve fitting. The following discusses the least-squares algorithm. In the least-squares algorithm, the error to be minimized is the sum of squares of error. This error is the offset or the residual of the data points from the curve. The error E may be defined as:

$$E = {{\sum }_{i} [ {y}_{i} - cos ( {Kx}_{i} ) ]}^{2} , I = 1 , … , N \qquad ( 6 )$$

To determine the value of K that minimizes E, we may take the derivative dE/dK, set it to zero, and solve for K. The solution is a closed-form solution for a set of N equations. Solving this set of equations is a known technique in linear algebra. Alternatively, an iterative procedure may be implemented. In this procedure, the optimum value of K is searched by iterating equation (6) until E is minimum over the set of N data points. Once K is found, the length L may be calculated from equation (5). In practice, the parameter c is replaced with the transmission line propagation speed, typically c/2.

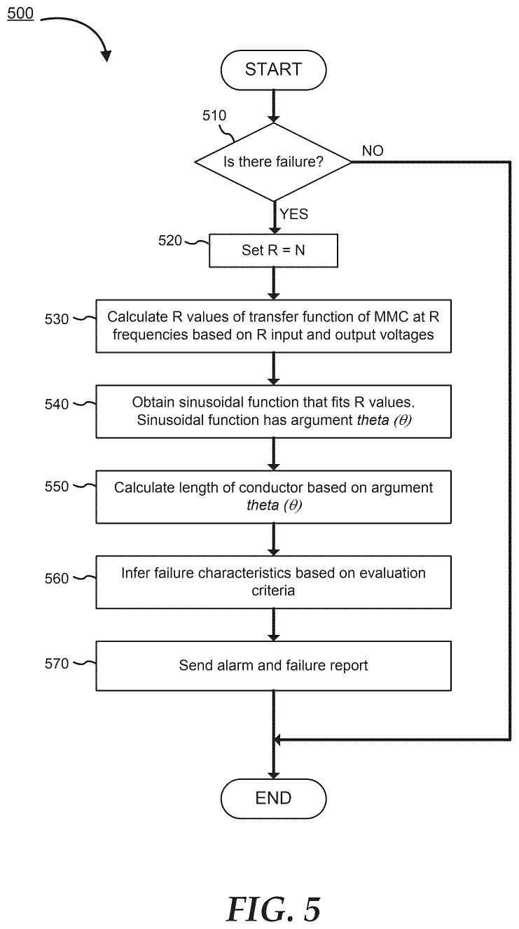

FIG. 5 is a flowchart illustrating a process 500 to monitor failure and/or measure length of a conductor according to an embodiment of the present disclosure. The process 500 may be performed partly or fully depending on the system configuration. In addition, the process 500 may include more or less than the operations shown in FIG. 5. The process 500 is typically performed by the control unit 140.

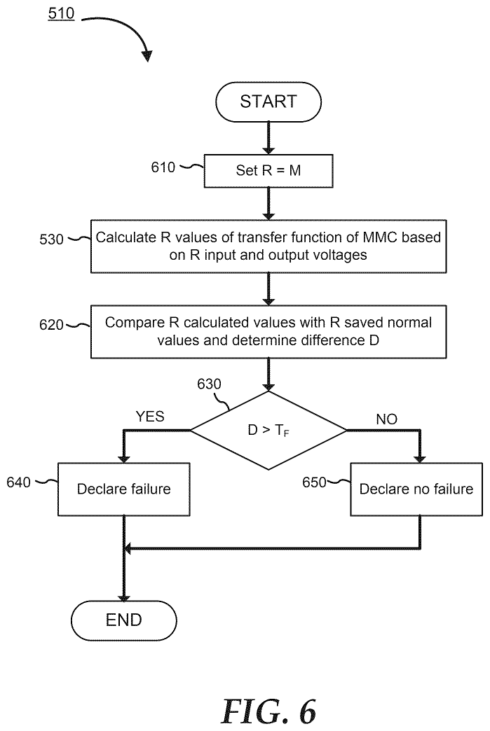

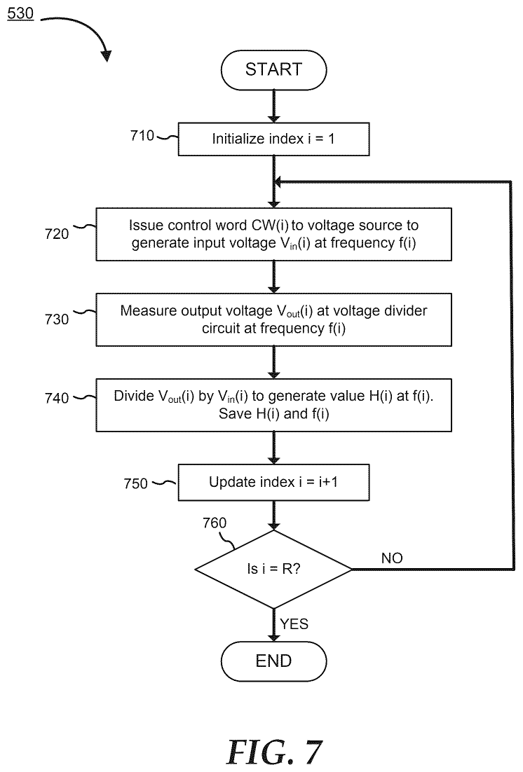

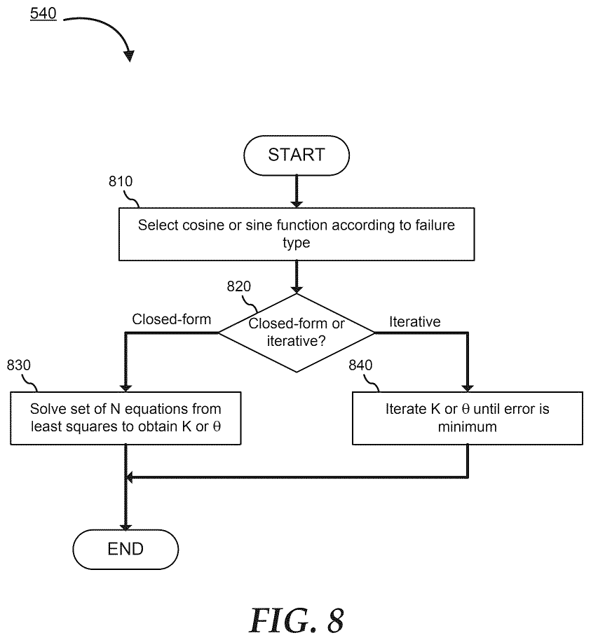

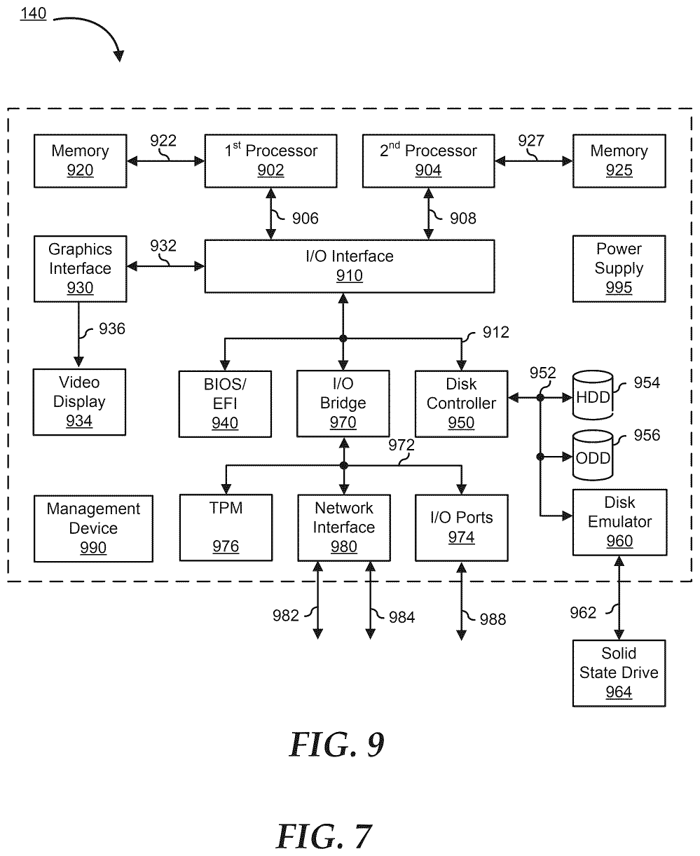

Upon START, the process 500 determines if there is a failure in the conductor 123 (Block 510). The failure may be any event that causes the conductor 123 to stop satisfactorily performing its assigned tasks. Typically, the failure may include an open circuit or a short circuit failure. Block 510 will be further described in FIG. 6. If there is no failure, or the conductor 123 performs normally, the process 500 is terminated. Otherwise, the process 500 sets R to N (Block 520), where R is a parameter used in the next function and N is the number of data points to be used in curve fitting. Next, the process 500 calculates R, which is now equal to N, values of the transfer function H(f) of MMC at R frequencies based on R input and output voltages (Block 530). The operation in block 530 will be described in FIG. 7. Then, the process 500 obtains a sinusoidal function that fits the R values the transfer function H(f) (Block 540). The sinusoidal function may be a cosine or a sine function and has argument theta (θ). The operation in Block 540 will be further described in FIG. 8. Next, the process 500 calculates the length L of the conductor based on the argument theta (Block 550). This calculation is based on equation (5). Then, the process 500 infers failure characteristics based on predefined evaluation criteria (Block 560). The failure characteristics may include the failure type (e.g., open circuit, short circuit), level of criticality based on the location of the failure as indicated by the length L and the local level of criticality. Evaluation criteria may include the level of criticality (discussed in connection with FIG. 2), the goodness of fit (the value of the minimized sum or squared error), etc. Next, the process 500 sends an alarm and/or failure report to some authority, the user, or some centralized control system (Block 570). The process 500 is then terminated.

FIG. 6 is a flowchart illustrating the process 510 to determine if there is a failure according to an embodiment of the present disclosure. There may be at least two ways to determine if a failure exists. The first way is based on comparison with a normal condition and the second way is based on the mathematical method of proof by contradiction. In the first way, the process 510 determines if there is a failure based on a comparison of the measured values with the values known to be normal. A large deviation from the normal values will be considered a failure. In one embodiment, the known normal values have been computed a priori and saved in a memory. These normal values are measured in the same operating conditions as the values that are being measured. The values to be measured and calculated may be selected according to some criteria. In one embodiment, these are the discrete values of the transfer function H(f) evaluated with given input voltages at predetermined frequencies.

For example, suppose it is desired to obtain the values of the transfer function H(f) at three frequency values f₁, f₂, f₃ (M=3). To do so, the system is powered up and put in normal operating conditions. It is observed and inspected that the system operates normally and there is no failure on the conductor 123. The control unit 140 then issues control words to the voltage source 121 to generate three input voltages Vᵢ₁, Vᵢ₂, and Vᵢ₃ at f₁, f₂, f₃. At each frequency, the output voltage Vₒ at the voltage divider circuit 122 is measured and the transfer function H(f)=Vₒ/Vᵢ is computed. In the end, three values of the normal condition Hₙ₁, Hₙ₂, and Hₙ₃ at f₁, f₂, and f₃, respectively, are calculated and saved. These three values will be used for comparison with subsequent runtime operations to determine if there is a failure. In subsequent runs, the same procedure is repeated at the same three frequencies to obtain three values Hᵣ₁, Hᵣ₂, and Hᵣ₃ at Vᵢ₁, Vᵢ₂, and Vᵢ₃ and f₁, f₂, and f₃. A comparison of Hᵣ₁, Hᵣ₂, and Hᵣ₃ with the respective normal Hₙ₁, Hₙ₂, and Hₙ₃ may be made and the error is computed. For example, a mean squared error may be computed as follows:

$$E = ( 1 / 3 ) \{ {( {H}_{r 1} - {H}_{n 1} )}^{2} + {( {H}_{r 2} - {H}_{n 2} )}^{2} + {( {H}_{r 3} - {H}_{n 3} )}^{2} \} \qquad ( 7 )$$

$$E = ( 1 / M ) {{\sum }_{i} [ {H}_{ri} - {H}_{ni} ]}^{2} i = 1 , … , M \qquad ( 8 )$$

If this error is less than a predetermined error threshold TF, then the runtime operation is considered normal. Otherwise, if this error is greater than TF, it is considered that a failure has occurred. This procedure is only to determine if a failure has occurred and is not related to the least-squares minimization procedure in curve fitting to determine the length L.

Upon START, the process 510 sets the number of values to be obtained, R=M (Block 610). This value is used as a parameter for the next operation that calculates R values of the transfer function of MMC based on R input and output voltages (Block 530). This operation is the same as the operation in block 530 shown in FIG. 5. Then, the process 510 compares R, now is equal to M, calculated values of the transfer function with R saved normal values and determine the difference D (Block 620). The difference D represents the error, e.g., the mean squared error in equation (8), or any other suitable type of error. Then, the process 510 determines if D is greater than the failure threshold T_{F} (Block 630). T_{F} is typically a constant that has been determined through experiments. If D is greater than T_{F}, i.e., the error is large, then the system is considered faulty, or there is a failure in the conductor 123. The process 510 then declares a failure (Block 640) and is terminated. If D is not greater than T_{F}, i.e., the error is very small, then the system is considered normal and there is no failure (Block 650). The process 510 is then terminated.

In one embodiment, determining whether there is a failure in the conductor 123 may be performed without using a set of known normal values. This is the second way as discussed above. This technique is based on the mathematical method of proof by contradiction. In this method, we assume that there is a failure condition and proceed to calculate the length L in the conductor 123 as if there were an open circuit or a short circuit. If the calculated length L is an invalid result, such as it is much longer than the actual length of the conductor 123, then we can conclude that the assumption of failure is false and consequently infer that there is no failure. This method, however, may require experimental data to back up the inference regarding the invalid results.

FIG. 7 is a flowchart illustrating the process 530 to calculate values of the transfer function H(f) according to an embodiment of the present disclosure. The process 530 is used in three places: (1) to generate M normal values for the transfer function H(f), (2) to perform measurements during determining if there is a failure (FIG. 6), and (3) to perform measurement of length L of the conductor 123 (FIG. 5). In essence, the process 530 calculates R values of the transfer function at R frequencies through controlling the voltage source 121.

Upon START, the process 530 initializes the index i to 1 as the starting point (Block 710). Next, the process 520 issues or generates the control word CW(i) to the voltage source 121 to generate input voltage Vᵢₙ(i) at a frequency f(i) (Block 720). This may include generating the control word CW(i) to the programmable voltage generator 310, the programmable frequency generator 320 and the integrator 330. Then, the process 530 measures the output voltage Vₒᵤₜ(i) at the voltage divider circuit 122 at frequency f(i) (Block 730). Next, the process 530 divides the output voltage Vₒᵤₜ(i) by the corresponding input voltage Vᵢₙ(i) to generate value H(i) at f(i), and saves H(i) and f(i) in a memory (Block 740). Then, the process 530 updates the index i by incrementing it by 1 (Block 750). Next, the process 530 determines if the index i is equal to the limit R (Block 760) where R is the number of values to be generated. If not, the process 530 returns to block 720 to continue calculating the next value. Otherwise, the process 530 is terminated.

FIG. 8 is a flowchart illustrating the process 540 to obtain the sinusoidal function that fits the R values H(f) according to an embodiment of the present disclosure. The sinusoidal function is a cosine function when the failure type is an open circuit and is a sine function when the failure type of a short circuit. The choice of which function to curve fit depends on knowledge of circuit configuration and the normal length of the conductor. In one embodiment, both functions may be used and the calculated lengths are subject to inference to determine which length is the correct one.

Upon START, the process 540 selects cosine or sine function according to the failure type (Block 810). Next, the process 540 determines whether a closed-form or an iterative solution is desired (Block 820). If the closed-form solution is selected, the process 540 solves a set of N equations from the least-squares formulation to obtain K in equation (6) (Block 830). If the iterative solution is selected, the process 540 iterates equation (6) by varying K until the error becomes minimized (Block 840). From this calculated value of K, the length L can be computed. The process 540 is then terminated.

FIG. 9 illustrates a generalized embodiment of an information handling system similar to the system 100 or the control circuit 140 shown in FIG. 1. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. The term “information handling system” may refer to a processing system, a control circuit, a control processor, or any processing apparatus that processes or handles information, data, or control or status words. For example, information handling system 100 or 140 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 140 can include processing resources for executing machine-executable code, such as a central processing unit (CPU), a programmable logic array (PLA), an embedded device such as a System-on-a-Chip (SoC), or other control logic hardware. Information handling system 140 can also include one or more computer-readable medium for storing machine-executable code, such as software or data. Additional components of information handling system 140 can include one or more storage devices that can store machine-executable code, one or more communications ports for communicating with external devices, and various input and output (I/O) devices, such as a keyboard, a mouse, and a video display. Information handling system 140 can also include one or more buses operable to transmit information between the various hardware components.

Information handling system 140 can include devices or modules that embody one or more of the devices or modules described below, and operates to perform one or more of the methods described below. Information handling system 140 includes first and second processors 902 and 904, an input/output (I/O) interface 910, memories 920 and 925, a graphics interface 930, a basic input and output system/universal extensible firmware interface (BIOS/UEFI) module 40, a disk controller 950, a hard disk drive (HDD) 954, an optical disk drive (ODD) 956, a disk emulator 960 connected to an external solid state drive (SSD) 962, an I/O bridge 970, one or more add-on resources 974, a trusted platform module (TPM) 976, a network interface 980, a management device 990, and a power supply 995. Processors 902 and 904, I/O interface 910, memory 920, graphics interface 930, BIOS/UEFI module 940, disk controller 950, HDD 954, ODD 956, disk emulator 960, SSD 962, I/O bridge 970, add-on resources 974, TPM 976, and network interface 980 operate together to provide a host environment of information handling system 140 that operates to provide the data processing functionality of the information handling system. The host environment operates to execute machine-executable code, including platform BIOS/UEFI code, device firmware, operating system code, applications, programs, and the like, to perform the data processing tasks associated with information handling system 140. Processors 902 and 904 may operate as the processor 142 and memories 920 and 925 may operate as the memory 144 shown in FIG. 1.

In the host environment, processor 902 is connected to I/O interface 910 via processor interface 906, and processor 904 is connected to the I/O interface via processor interface 908. Memory 920 is connected to processor 902 via a memory interface 922. Memory 925 is connected to processor 904 via a memory interface 927. Graphics interface 930 is connected to I/O interface 910 via a graphics interface 932, and provides a video display output 936 to a video display 934. In a particular embodiment, information handling system 140 includes separate memories that are dedicated to each of processors 902 and 904 via separate memory interfaces. An example of memories 920 and 930 include random access memory (RAM) such as static RAM (SRAM), dynamic RAM (DRAM), non-volatile RAM (NV-RAM), or the like, read only memory (ROM), another type of memory, or a combination thereof. Processor 902 and/or processor 904 may process data or information to be displayed on monitor 150 (shown in FIG. 1) in two separate screens 151 and 152. The data to be displayed may include pixel data 231 and pixel data 232 shown in FIG. 3.

BIOS/UEFI module 940, disk controller 950, and I/O bridge 970 are connected to I/O interface 910 via an I/O channel 912. An example of I/O channel 912 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 910 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 940 includes BIOS/UEFI code operable to detect resources within information handling system 140, to provide drivers for the resources, initialize the resources, and access the resources. BIOS/UEFI module 940 includes code that operates to detect resources within information handling system 140, to provide drivers for the resources, to initialize the resources, and to access the resources.

Disk controller 950 includes a disk interface 952 that connects the disk controller to HDD 954, to ODD 956, and to disk emulator 960. An example of disk interface 952 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 960 permits SSD 964 to be connected to information handling system 140 via an external interface 962. An example of external interface 962 includes a USB interface, an IEEE 1394 (Firewire) interface, a proprietary interface, or a combination thereof. Alternatively, solid-state drive 964 can be disposed within information handling system 140.

I/O bridge 970 includes a peripheral interface 972 that connects the I/O bridge to I/O port or add-on resource 974, to TPM 976, and to network interface 980. Peripheral interface 972 can be the same type of interface as I/O channel 912, or can be a different type of interface. As such, I/O bridge 970 extends the capacity of I/O channel 912 where peripheral interface 972 and the I/O channel are of the same type, and the I/O bridge translates information from a format suitable to the I/O channel to a format suitable to the peripheral channel 972 where they are of a different type. I/O port 974 can include a parallel or serial I/O channel, a data storage system, an additional graphics interface, a network interface card (NIC), a sound/video processing card, another add-on resource, or a combination thereof. In one embodiment, the I/O port provides interface to transmit control words to, or read status words from, the monitor and measurement circuit 120 (in FIG. 1). I/O port 974 can be on a main circuit board, on separate circuit board or add-in card disposed within information handling system 140, a device that is external to the information handling system, or a combination thereof.

Network interface 980 represents a NIC disposed within information handling system 140, on a main circuit board of the information handling system, integrated onto another component such as I/O interface 910, in another suitable location, or a combination thereof. Network interface device 980 includes network channels 982 and 984 that provide interfaces to devices that are external to information handling system 140. In a particular embodiment, network channels 982 and 984 are of a different type than peripheral channel 972 and network interface 980 translates information from a format suitable to the peripheral channel to a format suitable to external devices. An example of network channels 982 and 984 includes InfiniBand channels, Fibre Channel channels, Gigabit Ethernet channels, proprietary channel architectures, or a combination thereof. Network channels 982 and 984 can be connected to external network resources (not illustrated). The network resource can include another information handling system, a data storage system, another network, a grid management system, another suitable resource, or a combination thereof.

Management device 990 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 140. In particular, management device 990 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 140, such as system cooling fans and power supplies. Management device 990 can include a network connection to an external management system, and the management device can communicate with the management system to report status information for information handling system 200, to receive BIOS/UEFI or system firmware updates, or to perform other task for managing and controlling the operation of information handling system 140. Management device 990 can operate off of a separate power plane from the components of the host environment so that the management device receives power to manage information handling system 140 where the information handling system is otherwise shut down. An example of management device 990 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 990 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An apparatus comprising:
a monitor and measurement circuit (MMC) comprising:
voltage divider circuit connected to a conductor which is placed on a path through circuit elements, and;
a voltage source applied to voltage divider circuit to drive the voltage divider circuit at N frequencies;
a processor; and
a memory containing instructions that, when executed by the processor, cause the processor to perform operations comprising:
calculating N values of a transfer function of the MMC at the N frequencies,
obtaining a sinusoidal function that fits the N values, the sinusoidal function having an argument, and
calculating length of the conductor based on the argument.

2. The apparatus of claim 1 wherein the conductor is a leak detector rope.

3. The apparatus of claim 1 wherein calculating the N values comprises:
generating N input voltages at the voltage source at the N frequencies;
measuring N output voltages at the voltage divider circuit; and
dividing the N output voltages by the N input voltages at the N frequencies, respectively, to generate the N values.

4. The apparatus of claim 1 wherein obtaining a sinusoidal function comprises:
fitting the N values to the sinusoidal function using a least squares minimization procedure.

5. The apparatus of claim 4 wherein fitting the N values to the sinusoidal function comprises calculating the argument to minimize a sum of squared errors over the N values.

6. The apparatus of claim 1 wherein calculating the length of the conductor comprises multiplying the calculated argument with a constant.

7. The apparatus of claim 1 wherein the failure type is one of a short-circuit failure and an open circuit failure.

8. The apparatus of claim 7 wherein the sinusoidal function is a cosine function and a sine function when the failure type is the open circuit failure and the short-circuit failure, respectively.

9. The apparatus of claim 8 wherein the operations further comprise:
characterizing regions of the conductor based on criticality of components in a vicinity of the path.

10. The apparatus of claim 9 wherein characterizing the regions of the conductor is further based on criticality of components in a vicinity of the path.

11. A method comprising:
calculating, at N frequencies, N values of a transfer function of a monitor and measurement circuit (MMC) formed by a voltage source and a voltage divider circuit connected to a conductor having a failure type,
obtaining a sinusoidal function that fits the N values according to the failure type, the sinusoidal function having an argument, and
calculating length of the conductor based on the argument,
wherein the conductor is placed on a path through circuit elements.

12. The method of claim 11 wherein the conductor is a leak detector rope.

13. The method of claim 11 wherein calculating the N values comprises:
generating N input voltages at the voltage source at the N frequencies;
measuring N output voltages at the voltage divider circuit; and
dividing the N output voltages by the N input voltages at the N frequencies, respectively, to generate the N values.

14. The method of claim 11 wherein obtaining a sinusoidal function comprises:
fitting the N values to the sinusoidal function using a least squares minimization procedure.

15. The method of claim 14 wherein fitting the N values to the sinusoidal function comprises calculating the argument to minimize a sum of squared errors over the N values.

16. The method of claim 1 wherein calculating the length of the conductor comprises multiplying the calculated argument with a constant.

17. The method of claim 11 wherein the failure type is one of a short-circuit failure and an open circuit failure.

18. The method of claim 17 wherein the sinusoidal function is a cosine function and a sine function when the failure type is the open circuit failure and the short-circuit failure, respectively.

19. The method of claim 11 further comprising:
characterizing regions of the conductor based on criticality of components in a vicinity of the path and the length.

20. An information handling system, comprising:
a cooling unit to cool circuit elements; and
a leak detector configured to detect leak from the cooling unit, comprising:
a voltage divider circuit connected to a conductor to form a monitor and measurement circuit (MMC), the conductor being placed on a path through the circuit elements,
a voltage source applied to voltage divider circuit to drive the MMC at N frequencies,
a processor, and
a memory containing instructions that, when executed by the processor, cause the processor to perform operations comprising:
calculating N values of a transfer function of the MMC at the N frequencies,
obtaining a sinusoidal function that fits the N values, the sinusoidal function having an argument, and
calculating length of the conductor based on the argument.
